(19) United States
(12) Patent Application Publication
(10) Pub. No.: US 2019/0050103 A1
(43) Pub. Date: Feb. 14, 2019

(54) IN-VEHICLE INFOTAINMENT SYSTEM TOUCH USER INTERACTION METHOD AND APPARATUS

(71) Applicant: Intel Corporation, Santa Clara, CA (US)

(72) Inventor: Dibyendu Chatterjee, Bangalore (IN)

(21) Appl. No.: 15/829,501

(22) Filed: Dec. 1, 2017

(51) Int. Cl. G06F 3/041; B60K 37/06; B60K 35/00; G06F 3/0488

(52) U.S. Cl. CPC G06F 3/0416; B60K 37/06; B60K 35/00; G06F 3/0488; B60K 2350/106; B60K 2350/901; B60K 2350/903; B60K 2350/906; B60K 2350/1028

(57) ABSTRACT

Apparatuses, methods and storage media associated with user interactions with an IVI system are disclosed herein. In embodiments, an apparatus for providing infotainment system may include a plurality of signal sources to generate a plurality of signals to correspondingly propagate along a plurality of signal paths; and a plurality of sensors complementarily arranged to the plurality of signal sources to receive the signals, defining terminuses of the signal paths except when one or more of the signals are blocked or interfered with, preventing the one or more signals from reaching the sensors. The signals sources and the sensors may be further complementarily arranged to a touch sensitive screen of an IVI system. Further, blockage or inference of the signals may be used to determine or at least contribute in a determination of whether the touch sensitive screen is being interacted from a first side or a second side of the vehicle. Other embodiments may be described and claimed.

### TECHNICAL FIELD

The present disclosure relates to the field of in-vehicle infotainment system, in particular, to user interaction methods, apparatuses, and storage medium associated with in-vehicle infotainment systems.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

The Human Machine Interface (HMI) design for an In-Vehicle Infotainment (IVI) System is very challenging owning to the fact that the user is expected to interact with the HMI while potentially operating the vehicle at 60 miles per hour (mph) or more. This problem becomes more pronounced while driving in countries/jurisdictions with higher speed limits or chaotic/unmanaged traffic. Driver distraction is a potent cause for accidents, and asking the driver to concentrate on an IVI system while driving may be imprudent.

But, on the other hand, the same IVI system has to be tailored for the co-passenger as well, who is not required to pay attention to the traffic and/or pedestrian conditions on the road. The co-passenger might be more interested in detailed information and/or more compact layouts.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an overview of an environment for incorporating and using the IVI system user interaction technology of the present disclosure, in accordance with various embodiments.

FIGS. 2-3 illustrate IVI system user interaction technology of the present disclosure, in accordance with various embodiments.

FIG. 4 illustrates an example touch sensitive screen of an IVI system, incorporated with the user interaction technology of the present disclosure, in accordance with various embodiments.

FIG. 5 illustrates a component view of an example computer-assisted or autonomous vehicle system having an IVI system incorporated with the user interaction technology of the present disclosure, in accordance with various embodiments.

FIG. 6 illustrates an example user interaction process for an IVI system, in accordance with various embodiments.

FIG. 7 illustrates an example computer system, suitable for use to practice the present disclosure (or aspects thereof), in accordance with various embodiments.

FIG. 8 illustrates an example storage medium with instructions configured to enable an IVI system to practice the present disclosure, in accordance with various embodiments.

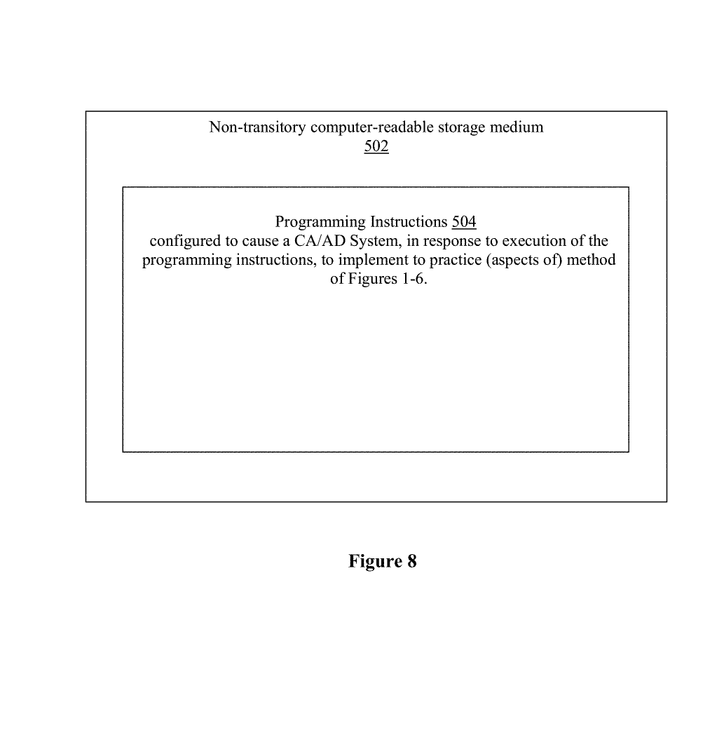

### DETAILED DESCRIPTION

Apparatuses, methods and storage media associated with user interactions with an IVI system are disclosed herein. HMI designs of current IVI systems do not differentiate between driver or passenger interactions. Same set of infotainment sub-systems, and/or functions of infotainment sub-systems are offered or not offered (using the same layout and/or design elements) when the IVI system host vehicle is in motion, regardless of whether it is a driver or a passenger of the host vehicle interacting with the IVI system.

To improve over prior art IVI systems, in embodiments of the present disclosure, an apparatus for providing infotainment system may include a plurality of signal sources to generate a plurality of signals to correspondingly propagate along a plurality of signal paths; and a plurality of sensors complementarily arranged to the plurality of signal sources to receive the signals, defining terminuses of the signal paths except when one or more of the signals are blocked or interfered with, preventing the one or more signals from reaching the sensors. The signals sources and the sensors may be further complementarily arranged to a touch sensitive screen of an IVI system, such that, blockage or inference of the signals may be used to determine or at least contribute in a determination of whether the touch sensitive screen is being interacted from a first side or a second side of the host vehicle of the IVI system.

In embodiments, the plurality of signal sources and the plurality of sensors may be complementarily arranged on a perimeter of the touch sensitive screen, surrounding the touch sensitive screen, with the signal paths occupying a plane parallel to the surface plane of the touch sensitive screen. In embodiments, the apparatus is the infotainment system embedded in the vehicle, having the touch sensitive screens with the signal sources and sensors embedded on the touch sensitive screen's perimeter. In embodiments, the plurality of signal sources may be infrared light emitting diodes (LED) that emit infrared optical signals, and the plurality of sensors may be infrared sensors.

In embodiments, the apparatus may be a computer-assisted or autonomous driving system disposed in a vehicle, or the vehicle itself, which may be a computer-assisted or autonomous driving vehicle. In embodiments, the vehicle may be an electric vehicle having a battery, such as, a Li-ion battery, or a combustion engine vehicle.

In the description to follow, reference is made to the accompanying drawings, which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Operations of various methods may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiments. Various additional operations may be performed and/or described operations may be omitted, split or combined in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used hereinafter, including the claims, the term “module” may refer to, be part of, or include an Application Specific Integrated Circuit (ASIC), an electronic circuit, a programmable combinational logic circuit (e.g., field programmable gate arrays (FPGA)), a processor (shared, dedicated, or group) and/or memory (shared, dedicated, or group) that execute one or more software or firmware programs generated from a plurality of programming instructions and/or other suitable components that provide the described functionality.

The terms “computer-assisted driving” and “semi-autonomous driving” as used herein are synonymous. The term “semi-autonomous driving” does not mean exactly 50% of driving is computer-assisted or automated. The percentage computer-assisted or automated may be anywhere from fraction of a % to almost 100%.

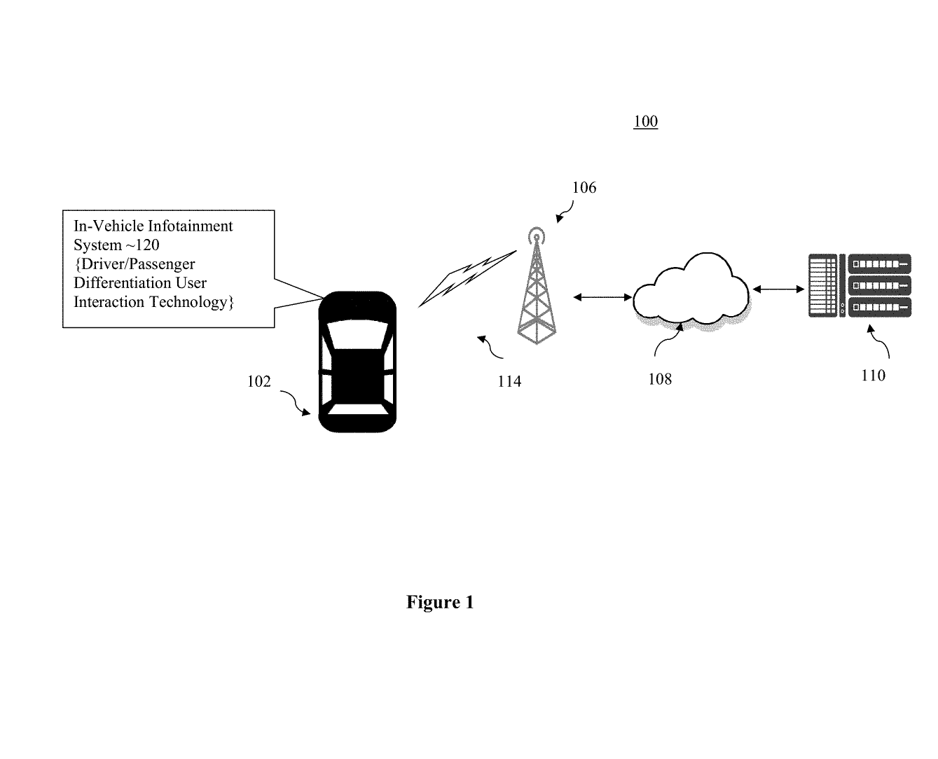

Referring now FIG. 1, an environment for incorporating and using the IVI system user interaction technology of the present disclosure, in accordance with various embodiments, is shown. As illustrated, in embodiments, example environment 100 may include vehicle 102, which may include IVI system 120 having user interaction technology of the present disclosure. IVI system 120 may include a number of infotainment subsystems, e.g., a navigation subsystem, a media subsystem, a vehicle status subsystem and so forth. Each infotainment subsystem may have different levels of functions. Each level of functions may have alternative layouts and/or design elements. For example, in the case of the navigation subsystem, it may allow a user to request navigation guidance for a new destination or only from a list of previously entered destination. As a further example, at least some of the functions of the navigation subsystem may have different versions of their user interfaces, some or more compact with more or smaller design elements, while others are less compact with less or larger design elements. These different infotainment systems, different functions and/or different user interfaces are to be selectively offered, depending on whether user interaction is from a first side, e.g., a driver side, or a second side, e.g., a passenger side, of vehicle 102.

In embodiments, IVI system 120 may be configured with user interaction technology of the present disclosure to discern whether user interaction with IVI system 120 is from a user situated at a first side (e.g., the driver side) of vehicle 102, or from a user situated at a second side (e.g., a passenger side) of vehicle 102. Depending on jurisdictions, the driver side of vehicle 102 may be the left hand side or the right hand side of the vehicle, with the passenger side located on the other side. IVI system 120, in turn, may offer different infotainment subsystems, different functions within an infotainment subsystem and/or different user interfaces within a function, depending on whether the interacting user is situated at the first (e.g., driver) side or at the second (e.g., passenger) side of vehicle 102.

In embodiments, IVI system 120, on its own or in response to the user interactions, may communicate or interact with one or more off-vehicle remote content servers 110, via a wireless signal repeater or base station on transmission tower 106 near vehicle 102, and one or more private and/or public wired and/or wireless networks 108. Examples of private and/or public wired and/or wireless networks 108 may include the Internet, the network of a cellular service provider, and so forth. It is to be understood that transmission tower 106 may be different towers at different times/locations, as vehicle 102 en routes to its destination.

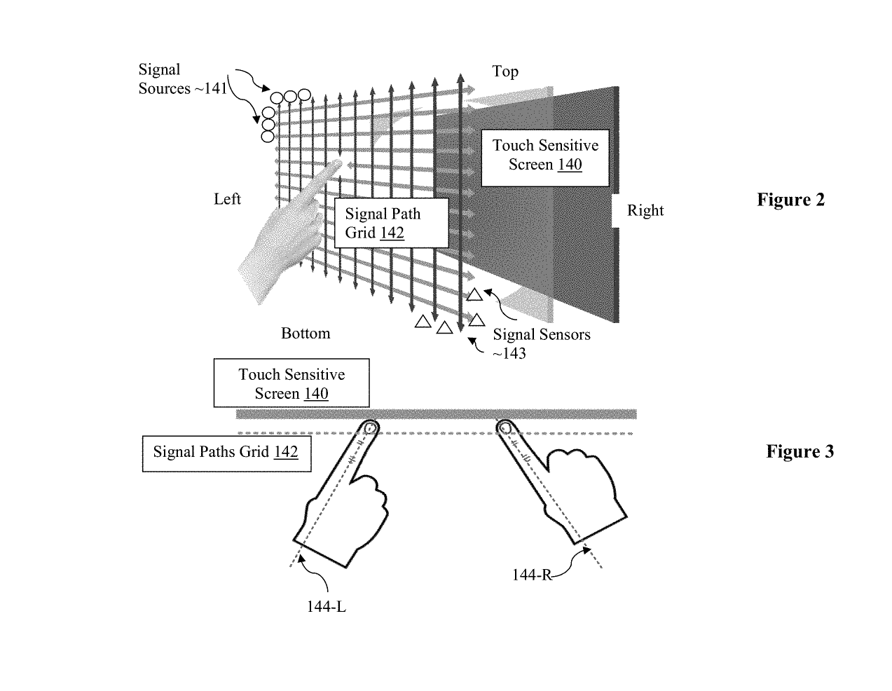

Referring now to FIGS. 2-3, wherein the IVI system user interaction technology of the present disclosure, in accordance with various embodiments, is illustrated. As shown, an arrangement 150 to discern whether a user is interacting with an IVI system from one side of a vehicle versus another side of the vehicle may include a plurality of signal sources 141 to generate a plurality of signals to correspondingly propagate along a plurality of signal paths; and a plurality of sensors 143 complementarily arranged to the plurality of signal sources 141 to receive the signals. In other words, sensors 143 are arranged to define the terminuses of the signal paths (except when one or more of the signals are blocked or interfered with, preventing the one or more signals from reaching sensors 143). Further, signals sources 141 and sensors 143 may be further complementarily arranged to a touch sensitive screen 140 of an IVI system. In embodiments, the plurality of signal sources 141 and the plurality of sensors 143 may be complementarily arranged on a perimeter of touch sensitive screen 140, surrounding touch sensitive screen 140, with the signal paths occupying a plane parallel to the surface plane of touch sensitive screen 140.

For the illustrated embodiments where touch sensitive screen 140 is substantially rectangular in shape having four substantially linear edges (top, right, bottom and left), a first subset of the signal sources 141 may be disposed along a first linear edge (e.g., the left edge), and a second subset of the signal sources 141 may be disposed along a second linear edge that is orthogonal to the first linear edge (e.g., the top edge). Further, a first subset of the sensors 143 may be complementarily disposed to the first subset of signal sources 141 along a third linear edge that is parallel to the first linear edge (e.g., the right edge), and a second subset of the sensors 143 may be complementarily disposed to the second subset of signal sources 141 along the fourth linear edge that is parallel to the second linear edge (e.g., the bottom edge). Thus, the signal paths of the signals generated by signal sources 141 may form a signal path grid 142 on a plane that is parallel to the surface plane of touch sensitive screen 140, in front of touch sensitive screen 140.

Note that while for ease of understanding, only a few of the first and second subsets of signal sources 141, and a few of the first and second subsets of signal sensors 142 are illustrated in FIG. 2, it is to be understood that in embodiments where it is desirable to discern whether a user is interacting with touch sensitive screen 140 from a first side or a second side of the host vehicle for the entire touch sensitive screen 140, the first and second subsets of signal sources and the first and second subsets of signal sensors respectively may span the corresponding linear edges. Further, it is to be noted that that the orientation notations of “top,” “right,” “bottom,” and “left” are merely for ease of understanding, they are not to be read as limiting on the user interaction of the present disclosure.

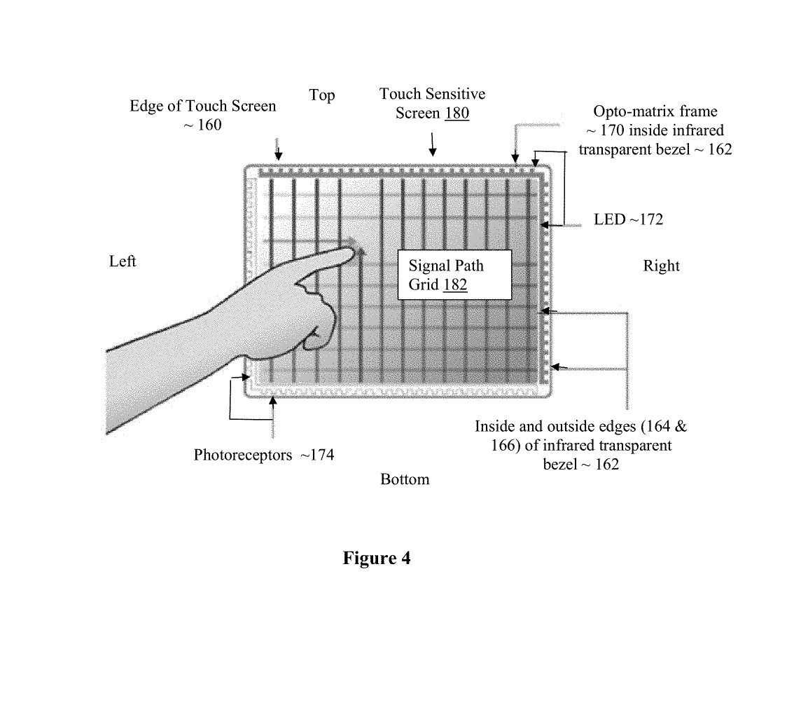

Accordingly, as illustrated in FIG. 3 (also in FIG. 4), a user interacting with touch sensitive screen 140 would necessarily block or otherwise interfere with the propagation of the signals to the sensors 143. Further, the blockage or inference characteristics would be different if the user is interacting with touch sensitive screen 140 from one side (e.g., a driver side) 144-L versus the other side (e.g., a passenger side) 144-R. Resultantly, blockage or inference of the signals (indicative by sensors 143 not receiving the corresponding signals) may be used to determine, or at least contribute in a determination of, whether touch sensitive screen 140 is being interacted from a first side (e.g., a driver side) 144-L or a second side (e.g., a passenger side) 144-R of the host vehicle of the IVI system.

In alternate embodiments, to increase accuracy the signal blockage or interference data may be combined with other sensor (e.g., image) data in determining whether a user is interacting with touch sensitive screen 140 from a first side (e.g., a driver side) 144-L or a second side (e.g., a passenger side) 144-R of the host vehicle of the IVI system.

Referring now to FIG. 4, wherein an example touch sensitive screen of an IVI system, incorporated with the user interaction technology of the present disclosure, in accordance with various embodiments, is illustrated. As shown, for the illustrated embodiments, example touch sensitive screen 180 may be substantially rectangular in shape have four substantially linear edges 160 (top, right, bottom, and left) with infrared transparent bezel 162 defining its perimeter. The width of infrared transparent bezel 162, defined by its inside and outside edges 164 and 166, may be of sufficient size to accommodate infrared light emitting diodes (LEDs) 172 and infrared photoreceptors 174. As earlier generally described for signal sources and signal receptors, infrared LEDs 172 and infrared photoreceptors 174 may be complementarily disposed therein. For example, a first subset of infrared LEDs 172 may be disposed along a first linear edge (e.g., the right edge), and a second subset of infrared LEDs 172 may be disposed along a second linear edge that is orthogonal to the first linear edge (e.g., the bottom edge). Correspondingly, a first subset of infrared photoreceptors 174 may be disposed along a third linear edge parallel to the first linear edge (e.g., the left edge), and a second subset infrared photoreceptors 174 may be disposed along a fourth linear edge that is orthogonal to the second linear edge (e.g., the top edge). (Note that infrared LEDs 172 and infrared receptors 174 are purposely described with different dispositions from the earlier general disposition descriptions of signal sources 141 and signal sensors 142 to illustrate signal sources 141 and signal sensors 142 may be complementarily disposed in any one of a number of manners. The descriptions are not to be read as limiting.)

Further, the infrared transparent bezel 162 may be raised relatively to the surface plane of touch sensitive screen 180, thereby allowing infrared signals generated by infrared LEDs 172 to propagate along corresponding signal paths, and sensed by corresponding infrared photoreceptors 174, forming signal path grid 182 on a plane parallel to the surface plane of touch sensitive screen 180.

Accordingly, a user interacting with touch sensitive screen 180 would necessarily block or otherwise interfere with the propagation of the infrared signals from infrared LEDs 172 to the infrared receptors 174. Further, the blockage or inference characteristics would be different if the user is interacting with touch sensitive screen 180 from one side (e.g., a driver side) versus the other side (e.g., a passenger side). Resultantly, blockage or inference of the infrared signals (indicative by photoreceptors 174 not receiving the corresponding infrared signals) may be used to determine, or at least contribute in a determination of, whether touch sensitive screen 180 is being interacted from a first side (e.g., a driver side) or a second side (e.g., a passenger side) of the host vehicle of the IVI system.

Before further describing the user interaction technology of the present disclosure, it should be noted that while for ease of understanding, FIGS. 2-4 have illustrated touch sensitive screen 140/180 as having a substantially rectangular shape, the description should not be read as limiting. In alternate embodiments, the touch sensitive screen may have any one of a number of shapes, circular, elliptical, square, pentagon, hexagon, octagon and so forth. In any of these embodiments, the signal sources and sensors may be complementarily arranged relative to each other (e.g., along the perimeter of the touch sensitive screen) and to the touch sensitive screen (with the signal paths formed on a plane parallel to the surface plane of the touch sensitive screen).

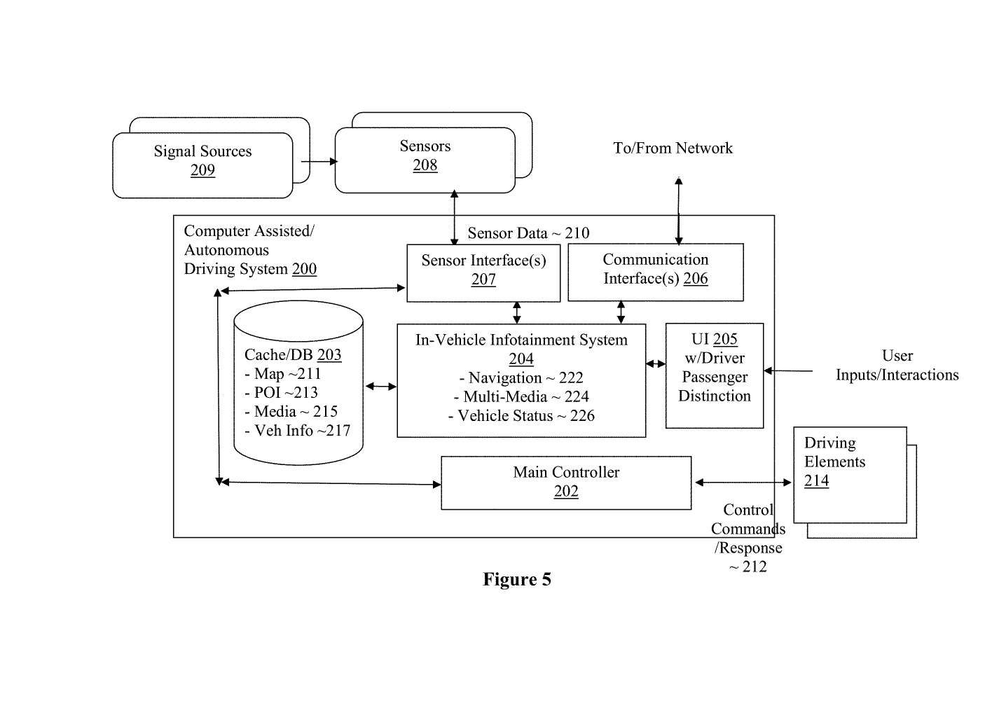

Referring now to FIG. 5, wherein a block diagram view of an example CA/AD system, in accordance with various embodiments, is shown. As illustrated, CA/AD system 200 may include one or more communication interfaces 206, one or more sensor interfaces 207, IVI system 204, cache/database 203, and main controller 202 coupled with each other as shown.

In embodiments, one or more sensor interfaces 207 may be configured to receive various sensor data 210 from sensors 208 disposed on the host vehicle of CA/AD system 200. In embodiments, sensor data 210 may comprise signal blockage or inference data of the earlier described signal path grid, due to user interaction with a touch sensitive screen associated with IVI system 204. For the illustrated embodiments, the signal path grid may be formed on a plane parallel to the surface plane of the touch sensitive screen by signal sources 209. In embodiments, sensor data 210 may further comprise camera data, radar data, acceleration data, GPS data, temperature data, humidity data, and so forth, collected respectively by a camera, a radar sensor, an accelerometer, a GPS sensor, a temperature sensor, a humidity sensor, and so forth, 208, disposed in the host vehicle of CA/AD system 200. In embodiments, one or more sensor interfaces 207 may include an input/output (I/O) or bus interface, such as a I² bus, an Integrated Drive Electronic (IDE) bus, a Serial Advanced Technology Attachment (SATA) bus, a Peripheral Component Interconnect (PCI) bus, a Universal Serial Bus (USB), a Near Field Communication (NFC) interface, a Bluetooth® interface, WiFi, and so forth, for receiving sensor data 210 from sensors 208.

In embodiments, one or more communication interfaces 206 may be configured to communicatively couple CA/AD system 200 to other devices in the host vehicle or to remote devices via a communication network (as earlier described in FIG. 1). In embodiments, one or more communication interfaces 206 may include a communication interface, such as 3G/4G, or LTE, to receive and send messages from and to other devices in the host vehicle, or from and to remote devices via one or more networks.

Continuing to refer to FIG. 5, in embodiments, sensor interface(s) 207, on receipt of sensor data 210, may forward sensor data 210 to IVI system 204 and/or main controller 202. In alternate embodiments, some sensor data 210 may be provided to IVI system 204 and/or main controller 202 directly, without going through sensor interface(s) 207.

In embodiments, as described earlier, IVI system 204 may include a number of infotainment subsystems, e.g., navigation subsystem 222, multi-media subsystem 224, vehicle status subsystem 226, and so forth. Additionally, each infotainment subsystem may include different functions or function levels. Further, each function may have different versions of user interface with different layouts and/or design elements.

In embodiments, IVI system 204 may further include an associated user interface assistant 205 incorporated with the user interaction technology of the present disclosure to discern whether user interactions with IVI system 204 are from a first side or a second side of the host vehicle.

In embodiments, user interface assistant 205, on receipt of sensor data 210 about user interactions, may process the sensor data to extract the signal blockage or interference characteristics, and determine, based on the signal blockage or interference characteristics, whether user interactions with IVI system 204 are from a first side or a second side of the host vehicle. In embodiments, on determination whether user interactions with IVI system 204 are from a first side or a second side of the host vehicle, user interface assistant 205 may output the results of the determination for infotainment subsystems 222-226, which may respond accordingly.

For some infotainment subsystems 222-226, they may ignore whether user interactions with IVI system 204 are from a first side or a second side of the host vehicle, and continue to offer or make available all functions. For other infotainment subsystems 222-226, they may restrict availability of some, but not all functions, and/or change the versions of the user interface being used, depending on whether user interactions with IVI system 204 are from a first side or a second side of the host vehicle. For still other infotainment subsystems 222-226, they may restrict availability of all functions, depending on whether user interactions with IVI system 204 are from a first side or a second side of the host vehicle.

In alternate embodiments, in lieu of outputting the results of user interaction determination for each infotainment subsystem to determine its level or amount of functions, if any, to offer, or which version of user interface to employ, user interface assistant 205 may be configured to instruct each infotainment subsystems with respect to the level or amount of functions, if any, the infotainment subsystems is to offer, or which version of user interface to employ. In still other embodiments, user interface assistant 205 may be configured to suspend or resume operation of an infotainment subsystem, depending on the result of the user interaction determination.

Still referring to FIG. 5, in embodiments, cache/database 203 may be configured to store various data of infotainment subsystems 222-226. In embodiments, cache/database 203 may be configured to store maps and/or points-of-interest (POI) data 211 for navigation subsystem 222, media data 213 (such as songs) for multi-media subsystem 224, and/or vehicle status information (such as tire pressure, engine oil level, and so forth) for vehicle status subsystem 226. In embodiments, infotainment subsystems 222-226 may be configured to access these data 211-217 in cache/database 203 during operation.

In embodiments, main controller 202 may be configured to receive sensor data 210, process sensor data 210, and based at least in part on the results of the processing, issue control commands 212 to driving elements 214 of the host vehicle (e.g., engine, brake, and so forth) to move/drive the host vehicle.

In embodiments, IVI system 204 and main controller 202 may be implemented in hardware, e.g., ASIC, or programmable combinational logic circuit (e.g., (FPGA)), or software (to be executed by a processor and memory arrangement), or combination thereof. For software implementations, in some embodiments, IVI system 204 and main controller 202 may share a common execution environment provided by the same processor and memory arrangement. In alternate embodiments, IVI system 204 and main controller 202 may be implemented to operate in different execution environments, e.g., IVI system 204 to operate in a general execution environment for applications, and main controller 202 to operate in a separate trusted/secured execution environment, that is separate, isolated and protected from the general execution environment for applications.

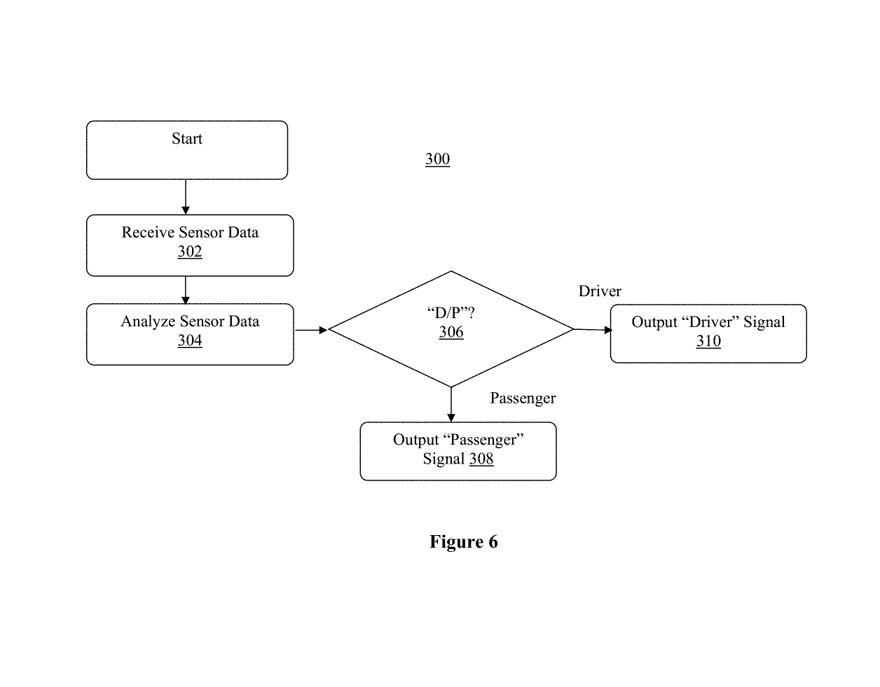

Referring now to FIG. 6, wherein an example user interaction process for an IVI system, in accordance with various embodiments, is shown. As illustrated, process 300 for user interaction with an IVI system may include operations performed in blocks 302-310. The operations may be performed by e.g., CA/AD system 200 of FIG. 2, in particular, by user interface assistant 205. In alternate embodiments, process 300 for user interaction with an IVI system may include more or less operations, or have some of the operations performed in different order.

Process 300 may start at block 302. At block 302, sensor data associated with signal blockage or inference with signal propagation on the earlier described signal path grid may be received. At block 304, the sensor data may be analyzed to extract the blockage or inference characteristics, and based on the blockage or inference characteristics, determine whether user interactions with the IVI system is from a driver side or a passenger side of the host vehicle.

At block 306, a determination may be made on whether the result of the user interaction determination indicates that user interaction is from the driver side (“D”) or the passenger side (“P”) of the host vehicle. If a result of the determination indicates that user interaction with the IVI system is from the passenger side, process 300 may proceed to block 308, and output an indicator denoting user interaction from the passenger side for the infotainment subsystems. In alternate embodiments, no action may be taken at block 308.

However, if a result of the determination indicates that user interaction with the IVI system is from the driver side, at block 310, an indicator denoting user interaction from the driver side may be outputted for the infotainment subsystems. In alternate embodiments, other actions may be taken to adjust the version of the user interface of a function being used, adjust the level or amount of functions offered by the various infotainment subsystems, or cause the level or amount of functions offered to be adjusted.

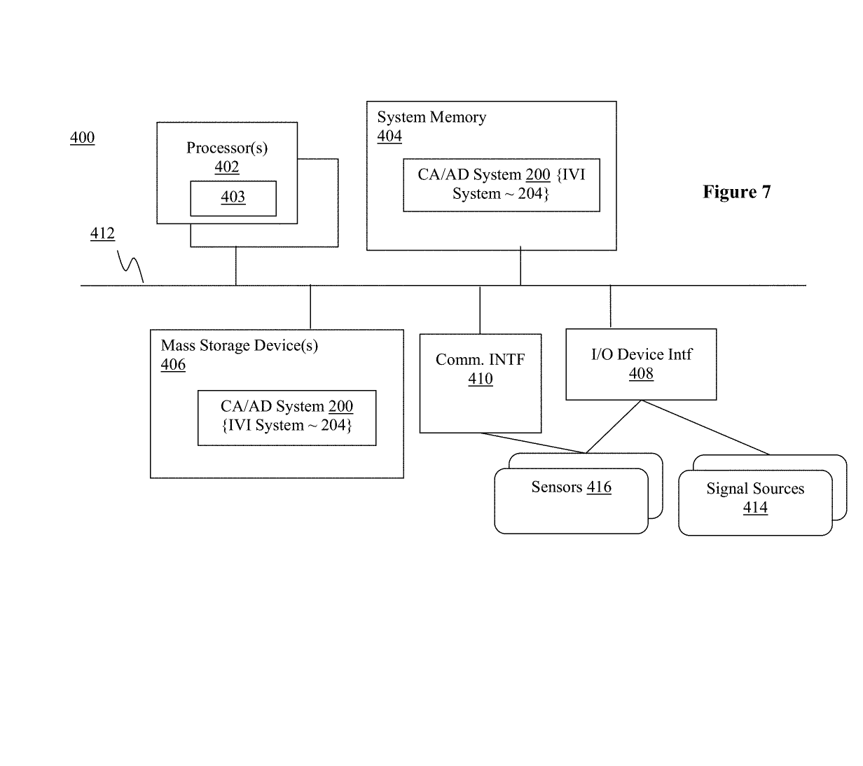

Referring now to FIG. 7, wherein a block diagram of a computer device suitable for practice aspects of the present disclosure, in accordance with various embodiments, is illustrated. As shown, in embodiments, computer device 400 may include one or more processors 402 and system memory 404. Each processor 402 may include one or more processor cores. In embodiments, one or more processors 402 may include one or more hardware accelerators (such as, FPGA) 403. System memory 404 may include any known volatile or non-volatile memory. Additionally, computer device 400 may include mass storage device(s) 406 (such as solid state drives), input/output device interface 408 (to interface with e.g., signal sources 414 and sensors 416) and communication interfaces 410 (such as network interface cards, modems and so forth). Examples of signals sources may include earlier described signal sources 141 and infrared LEDs 172. Examples of sensors may include earlier described signal sensors 143, infrared receptors 174, cameras, radars, GPS, temperature sensors, humidity sensors, and so forth. The elements may be coupled to each other via system bus 412, which may represent one or more buses. In the case of multiple buses, they may be bridged by one or more bus bridges (not shown).

Each of these elements may perform its conventional functions known in the art. In particular, system memory 404 and mass storage device(s) 406 may be employed to store a working copy and a permanent copy of the executable code of the programming instructions implementing the operations described earlier, e.g., but are not limited to, operations associated with CA/AD system 200 of FIG. 2, in particular, operation related to IVI system 204 of FIG. 2. The programming instructions may comprise assembler instructions supported by processor(s) 402 or high-level languages, such as, for example, C, that can be compiled into such instructions. In embodiments, some of the functions performed by parking analysis unit 204 may be implemented with hardware processor 403 instead.

The permanent copy of the executable code of the programming instructions and/or the bit streams to configure hardware accelerator 403 may be placed into permanent mass storage device(s) 406 or hardware accelerator 403 in the factory, or in the field, through, for example, a distribution medium (not shown), such as a compact disc (CD), or through communication interface 410 (from a distribution server (not shown)).

Except for the use of computer system 400 to host CA/AD system 200 (including IVI system 204, the constitutions of the elements 410-412 are otherwise known, and accordingly will not be further described.

Referring now to FIG. 5, wherein an example non-transitory computer-readable storage medium having instructions configured to practice all or selected ones of the operations associated with CA/AD system 200 (in particular, IVI system 204), earlier described, in accordance with various embodiments, is shown. As illustrated, non-transitory computer-readable storage medium 502 may include the executable code of a number of programming instructions 504. Executable code of programming instructions 504 may be configured to enable a system, e.g., IVI system 204, CA/AD system 200 or computer system 400, in response to execution of the executable code/programming instructions, to perform, e.g., various operations associated autonomous or semi-autonomous parking described with references to FIGS. 1-3. In alternate embodiments, executable code/programming instructions 504 may be disposed on multiple non-transitory computer-readable storage medium 502 instead. In still other embodiments, executable code/programming instructions 504 may be encoded in transitory computer readable medium, such as signals.

In embodiments, a processor may be packaged together with a computer-readable storage medium having some or all of executable code of programming instructions 504 configured to practice all or selected ones of the operations earlier described with references to FIG. 1-3. For one embodiment, a processor may be packaged together with such executable code 504 to form a System in Package (SiP). For one embodiment, a processor may be integrated on the same die with a computer-readable storage medium having such executable code 504. For one embodiment, a processor may be packaged together with a computer-readable storage medium having such executable code 504 to form a System on Chip (SoC). For at least one embodiment, the SoC may be utilized in, e.g., IVI system 203 or CA/AD system 200.

Thus, an improved method and apparatus for law enforcement assistance in the context of computer-aided or autonomous driving vehicles has been described. The approach may be especially helpful for law enforcement situations, such as Amber Alerts in the United States, where law enforcement related messages are issued to seek public assistance in locating persons and/or vehicles potentially associated with child abduction situations.

Example embodiments described include, but are not limited to:

Example 1 is an apparatus for providing infotainment in a vehicle, comprising: a plurality of signal sources to generate a plurality of signals to correspondingly propagate along a plurality of signal paths; and a plurality of sensors complementarily arranged to the plurality of signal sources to receive the signals, defining terminuses of the signal paths except when one or more of the signals are blocked or interfered with, preventing the one or more signals from reaching the sensors. The signals sources and the sensors are further complementarily arranged to a touch sensitive screen of an infotainment system of the vehicle; and blockage or inference of the signals are used to determine or at least contribute in a determination of whether the touch sensitive screen is being interacted from a first side or a second side of the vehicle.

Example 2 is example 1, wherein the plurality of signal sources and the plurality of sensors are complementarily arranged on a perimeter of the touch sensitive screen, surrounding the touch sensitive screen.

Example 3 is example 2, wherein the touch sensitive screen has a first linear edge, a second linear edge orthogonal to the first linear edge, a third linear edge parallel to the first linear edge, and a fourth linear edge parallel to the second linear edge; wherein a first subset of the signal sources are disposed along the first linear edge, and a second subset of the signal sources are disposed along the second linear edge; and wherein a first subset of the sensors are complementarily disposed to the first subset of signal sources along the third linear edge, and a second subset of the sensor are complementarily disposed to the second subset of signal sources along the fourth linear edge.

Example 4 is example 2, further comprising the touch sensitive screen, wherein the plurality of signal sources and the plurality of sensors are complementarily embedded on the perimeter of the touch sensitive screen, surrounding the touch sensitive screen.

Example 5 is example 4, wherein the apparatus is the infotainment system embedded in the vehicle, having the touch sensitive screens with the signal sources and sensors embedded on the touch sensitive screen's perimeter.

Example 6 is example 5, wherein the infotainment system comprises one or more infotainment subsystems that are available and used via the touch sensitive screen, when interacting with the touch sensitive screen from the second side, but not when interacting with the touch sensitive screen from the first side, when the vehicle is in motion.

Example 7 is example 6, wherein the one or more infotainment subsystems are first one or more infotainment subsystems, and wherein the infotainment system further comprises second one or more infotainment subsystems that are available and used via the touch sensitive screen, when interacting with the touch sensitive screen from either the first side or the second side, when the vehicle is in motion.

Example 8 is example 5, wherein the infotainment system comprises an infotainment subsystem having one or more infotainment functions that are available and used via the touch sensitive screen, when interacting with the touch sensitive screen from the second side, but not when interacting with the touch sensitive screen from the first side, when the vehicle is in motion.

Example 9 is example 8, wherein the one or more infotainment functions are first one or more infotainment functions, and wherein the infotainment subsystem further having second one or more infotainment functions that are available and used via the touch sensitive screen, when interacting with the touch sensitive screen from either the first side or the second side, when the vehicle is in motion.

Example 10 is example 5, wherein the infotainment system comprises an infotainment subsystem having an infotainment function that are available and used via the touch sensitive screen, employing a first version of an user interface, when interacting with the touch sensitive screen from the first side, and employing a second version of the user interface, when interacting with the touch sensitive screen from the second side, when the vehicle is in motion.

Example 11 is example 10, wherein the infotainment function is a first infotainment function, and wherein the infotainment subsystem further having a second infotainment function that are available and used via the touch sensitive screen, employing a same user interface, when interacting with the touch sensitive screen from either the first side or the second side, when the vehicle is in motion.

Example 12 is example 5, wherein the sensors further respectively output sensor data indicative of whether the sensors receive the corresponding signals; and wherein the infotainment system further comprises a user interface interaction assistant unit coupled to the sensors to determine whether the touch sensitive screen is being interacted from the first side or the second side of the vehicle.

Example 13 is any one of examples 1-12, wherein the plurality of signal sources are light emitting diodes (LED) that emit infrared optical signals, and the plurality of sensors are infrared sensors.

Example 14 is example 13, wherein the first side is a driver side of the vehicle, and second side is a passenger side of the vehicle.

Example 15 is a method for operating an infotainment system in a vehicle, comprising: determining, using a plurality of signal sources and a plurality of sensors, whether a touch sensitive screen of the infotainment system is being interacted from a first side or a second side of the vehicle; and dynamically offering a first level of infotainment function of an infotainment subsystem or first one or more infotainment subsystems of the infotainment system, if a result of the determining indicating a user is interacting with the touch sensitive screen from the second side of the vehicle, but not when the result of the determining indicating the user is interacting with the touch sensitive screen from the first side of the vehicle, when the vehicle is in motion.

Example 16 is example 15, further comprising dynamically offering a second level of infotainment function of the infotainment subsystem or second one or more infotainment subsystems of the infotainment system, regardless of whether the result of the determining indicating the user is interacting with the touch sensitive screen from either the first side or the second side of the vehicle, when the vehicle is in motion.

Example 17 is example 15 further comprising employing a first version of an user interface of an infotainment subsystem of the infotainment system, when interacting with the touch sensitive screen from the first side, and employing a second version of the user interface of the infotainment subsystem, when interacting with the touch sensitive screen from the second side, when the vehicle is in motion.

Example 18 is example 17, further comprising employing a same user interface of another infotainment subsystem of the infotainment system, when interacting with the touch sensitive screen from either the first side or the second side, when the vehicle is in motion.

Example 19 is example 15, wherein determining comprises determining which signals, if any, propagated from the plurality of signal sources, along a plurality of signal paths, did not reach the plurality of sensors.

Example 20 is example 19, wherein determining which signals, if any, propagated from the plurality of signal sources, along a plurality of signal paths, did not reach the plurality of sensors comprises determining which first signals, if any, propagated from a first subset of the plurality of signal sources, along a first plurality of signal paths, did not reach a first subset of the plurality of sensors, and determining which second signals, if any, propagated from a second subset of the plurality of signal sources, along a second plurality of signal paths, did not reach a second subset of the plurality of sensors, wherein the first and second signal paths are orthogonal to each other, and disposed on a plane parallel to a surface plane of the touch sensitive screen.

Example 21 is any one of examples 15-20, wherein determining comprises determining using a plurality of light emitting diodes (LED) that emit infrared optical signals, and a plurality of infrared sensors.

Example 22 is example 21, wherein the first side is a driver side of the vehicle, and second side is a passenger side of the vehicle.

Example 23 is at least one computer readable media (CRM) comprising a plurality of instructions arranged to cause an infotainment system embedded in a vehicle, in response to execution of the instructions by the infotainment system, to: receive sensor data from a plurality of sensors; and process the sensor data to determine and output a notification for one or more infotainment subsystems of the infotainment system indicating whether a user is interacting with a touch sensitive screen of the infotainment system from a first side of the vehicle or a second side of the vehicle. Further, at least a first of the one or more infotainment subsystems differentially offers a first set of functions in response to a result of the determination that indicates the user is interacting with the touch sensitive screen from the first side of the vehicle and a second set of functions in response to the result of the determination that indicates the user is interacting with the touch sensitive screen from the second side of the vehicle.

Example 24 is example 23, wherein to process the sensor data comprises to process the sensor data to determine which of the sensors are not able to receive signals from a plurality of signal sources propagated along a plurality of corresponding signal paths, wherein different ones of the sensors are not able to receive signals propagated from the plurality of signal sources along corresponding signal paths, when a user interacts with the touch sensitive screen from a first side or a second side of the vehicle.

Example 25 is example 24, wherein to process the sensor data to determine which of the sensors are able to receive signals from a corresponding plurality of signal sources comprises to process a first subset of the sensor data to determine which of a first subset of the sensors, if any, are not able to receive first signals from a first subset of signal sources propagated along a corresponding first subset of signal paths, and to process a second subset of the sensor data to determine which of a second subset of the sensors, if any, are not able to receive second signals from a second subset of signal sources propagated along a corresponding second subset of signal paths; wherein the first and second signal paths are orthogonal to each other, and disposed on a plane parallel to a surface plane of the touch sensitive screen.

Example 26 is example 23, wherein at least a second of the one or more infotainment subsystems differentially a first version of an user interface in response to a result of the determination that indicates the user is interacting with the touch sensitive screen from the first side of the vehicle and a second version of the user interface in response to the result of the determination that indicates the user is interacting with the touch sensitive screen from the second side of the vehicle.

Example 27 is example 24, wherein the signal sources are light emitting diodes (LED).

Example 28 is example 23, wherein the sensors are infrared sensors.

Example 29 is any one of examples 23-28 , wherein the first side is a driver side of the vehicle, and second side is a passenger side of the vehicle.

Example 30 is an apparatus for operating an infotainment system embedded in a vehicle, comprising: a touch sensitive screen; means for determining whether the touch sensitive screen of the infotainment system is being interacted from a first side or a second side of the vehicle; and means for dynamically offering a first level of infotainment function of the infotainment subsystem or first one or more infotainment subsystems of the infotainment system, if a result of the determining indicating a user is interacting with the touch sensitive screen from the second side of the vehicle, but not when the result of the determining indicating the user is interacting with the touch sensitive screen from the first side of the vehicle, when the vehicle is in motion.

Example 31 is example 30, wherein means for dynamically offering further comprising means for dynamically offering a second level of infotainment function of the infotainment subsystem or second one or more infotainment subsystems of the infotainment system, if a result of the determining indicating a user is interacting with the touch sensitive screen from either the first side or the second side of the vehicle, when the vehicle is in motion.

Example 32 is example 30, wherein the means for determining includes a plurality of signal sources and a plurality of sensors,

Example 33 is example 32, wherein the plurality of signal sources and the plurality of sensors are complementarily arranged on a perimeter of the touch sensitive screen, surrounding the touch sensitive screen.

Example 34 is example 33, wherein the touch sensitive screen has a first linear edge, a second linear edge orthogonal to the first linear edge, a third linear edge parallel to the first linear edge, and a fourth linear edge parallel to the second linear edge; wherein a first subset of the signal sources are disposed along the first linear edge, and a second subset of the signal sources are disposed along the second linear edge; and wherein a first subset of the sensors are complementarily disposed to the first subset of signal sources along the third linear edge, and a second subset of the sensor are complementarily disposed to the second subset of signal sources along the fourth linear edge.

Example 35 is example 33, wherein the plurality of signal sources and the plurality of sensors are complementarily embedded on the perimeter of the touch sensitive screen, surrounding the touch sensitive screen.

Example 36 is any one of examples 30-35, wherein the plurality of signal sources are light emitting diodes (LED) that emit infrared optical signals, and the plurality of sensors are infrared sensors.

Example 37 is example 36, wherein the first side is a driver side of the vehicle, and second side is a passenger side of the vehicle.

Example 38 is example 30, wherein the infotainment system comprises an infotainment subsystem having an infotainment function that are available and used via the touch sensitive screen, employing a first version of an user interface, when interacting with the touch sensitive screen from the first side, and employing a second version of the user interface, when interacting with the touch sensitive screen from the second side, when the vehicle is in motion.

Example 39 is example 38, wherein the infotainment function is a first infotainment function, and wherein the infotainment subsystem further having a second infotainment function that are available and used via the touch sensitive screen, employing a same user interface, when interacting with the touch sensitive screen from either the first side or the second side, when the vehicle is in motion.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. An apparatus for providing infotainment in a vehicle, comprising:
a plurality of signal sources to generate a plurality of signals to correspondingly propagate along a plurality of signal paths; and
a plurality of sensors complementarily arranged to the plurality of signal sources to receive the signals, defining terminuses of the signal paths except when one or more of the signals are blocked or interfered with, preventing the one or more signals from reaching the sensors;
wherein the signals sources and the sensors are further complementarily arranged to a touch sensitive screen of an infotainment system of the vehicle; and wherein blockage or inference of the signals are used to determine or at least contribute in a determination of whether the touch sensitive screen is being interacted from a first side or a second side of the vehicle.

2. The apparatus of claim 1, wherein the plurality of signal sources and the plurality of sensors are complementarily arranged on a perimeter of the touch sensitive screen, surrounding the touch sensitive screen.

3. The apparatus of claim 2, wherein the touch sensitive screen has a first linear edge, a second linear edge orthogonal to the first linear edge, a third linear edge parallel to the first linear edge, and a fourth linear edge parallel to the second linear edge; wherein a first subset of the signal sources are disposed along the first linear edge, and a second subset of the signal sources are disposed along the second linear edge; and wherein a first subset of the sensors are complementarily disposed to the first subset of signal sources along the third linear edge, and a second subset of the sensor are complementarily disposed to the second subset of signal sources along the fourth linear edge.

4. The apparatus of claim 2, further comprising the touch sensitive screen, wherein the plurality of signal sources and the plurality of sensors are complementarily embedded on the perimeter of the touch sensitive screen, surrounding the touch sensitive screen.

5. The apparatus of claim 4, wherein the apparatus is the infotainment system embedded in the vehicle, having the touch sensitive screens with the signal sources and sensors embedded on the touch sensitive screen's perimeter.

6. The apparatus of claim 5, wherein the infotainment system comprises one or more infotainment subsystems that are available and used via the touch sensitive screen, when interacting with the touch sensitive screen from the second side, but not when interacting with the touch sensitive screen from the first side, when the vehicle is in motion.

7. The apparatus of claim 6, wherein the one or more infotainment subsystems are first one or more infotainment subsystems, and wherein the infotainment system further comprises second one or more infotainment subsystems that are available and used via the touch sensitive screen, when interacting with the touch sensitive screen from either the first side or the second side, when the vehicle is in motion.

8. The apparatus of claim 5, wherein the infotainment system comprises an infotainment subsystem having one or more infotainment functions that are available and used via the touch sensitive screen, when interacting with the touch sensitive screen from the second side, but not when interacting with the touch sensitive screen from the first side, when the vehicle is in motion.

9. The apparatus of claim 8, wherein the one or more infotainment functions are first one or more infotainment functions, and wherein the infotainment subsystem further having second one or more infotainment functions that are available and used via the touch sensitive screen, when interacting with the touch sensitive screen from either the first side or the second side, when the vehicle is in motion.

10. The apparatus of claim 5, wherein the infotainment system comprises an infotainment subsystem having an infotainment function that are available and used via the touch sensitive screen, employing a first version of an user interface, when interacting with the touch sensitive screen from the first side, and employing a second version of the user interface, when interacting with the touch sensitive screen from the second side, when the vehicle is in motion.

11. The apparatus of claim 10, wherein the infotainment function is a first infotainment function, and wherein the infotainment subsystem further having a second infotainment function that are available and used via the touch sensitive screen, employing a same user interface, when interacting with the touch sensitive screen from either the first side or the second side, when the vehicle is in motion.

12. The apparatus of claim 5, wherein the sensors further respectively output sensor data indicative of whether the sensors receive the corresponding signals; and wherein the infotainment system further comprises a user interface interaction assistant unit coupled to the sensors to determine whether the touch sensitive screen is being interacted from the first side or the second side of the vehicle.

13. The apparatus of claim 1, wherein the plurality of signal sources are light emitting diodes (LED) that emit infrared optical signals, and the plurality of sensors are infrared sensors.

14. The apparatus of claim 1, wherein the first side is a driver side of the vehicle, and second side is a passenger side of the vehicle.

15. A method for operating an infotainment system in a vehicle, comprising:
determining, using a plurality of signal sources and a plurality of sensors, whether a touch sensitive screen of the infotainment system is being interacted from a first side or a second side of the vehicle; and
dynamically offering a first level of infotainment function of an infotainment subsystem or first one or more infotainment subsystems of the infotainment system, if a result of the determining indicating a user is interacting with the touch sensitive screen from the second side of the vehicle, but not when the result of the determining indicating the user is interacting with the touch sensitive screen from the first side of the vehicle, when the vehicle is in motion.

16. The method of claim 15, further comprising dynamically offering a second level of infotainment function of the infotainment subsystem or second one or more infotainment subsystems of the infotainment system, regardless of whether the result of the determining indicating the user is interacting with the touch sensitive screen from either the first side or the second side of the vehicle, when the vehicle is in motion.

17. The method of claim 15 further comprising employing a first version of an user interface of an infotainment subsystem of the infotainment system, when interacting with the touch sensitive screen from the first side, and employing a second version of the user interface of the infotainment subsystem, when interacting with the touch sensitive screen from the second side, when the vehicle is in motion.

18. The method of claim 17, further comprising employing a same user interface of another infotainment subsystem of the infotainment system, when interacting with the touch sensitive screen from either the first side or the second side, when the vehicle is in motion.

19. The method of claim 15, wherein determining comprises determining which signals, if any, propagated from the plurality of signal sources, along a plurality of signal paths, did not reach the plurality of sensors.

20. The method of claim 19, wherein determining which signals, if any, propagated from the plurality of signal sources, along a plurality of signal paths, did not reach the plurality of sensors comprises determining which first signals, if any, propagated from a first subset of the plurality of signal sources, along a first plurality of signal paths, did not reach a first subset of the plurality of sensors, and determining which second signals, if any, propagated from a second subset of the plurality of signal sources, along a second plurality of signal paths, did not reach a second subset of the plurality of sensors, wherein the first and second signal paths are orthogonal to each other, and disposed on a plane parallel to a surface plane of the touch sensitive screen.

21. At least one computer readable media (CRM) comprising a plurality of instructions arranged to cause an infotainment system embedded in a vehicle, in response to execution of the instructions by the infotainment system, to:
receive sensor data from a plurality of sensors; and
process the sensor data to determine and output a notification for one or more infotainment subsystems of the infotainment system indicating whether a user is interacting with a touch sensitive screen of the infotainment system from a first side of the vehicle or a second side of the vehicle;
wherein at least a first of the one or more infotainment subsystems differentially offers a first set of functions in response to a result of the determination that indicates the user is interacting with the touch sensitive screen from the first side of the vehicle and a second set of functions in response to the result of the determination that indicates the user is interacting with the touch sensitive screen from the second side of the vehicle.

22. The CRM of claim 21, wherein to process the sensor data comprises to process the sensor data to determine which of the sensors are not able to receive signals from a plurality of signal sources propagated along a plurality of corresponding signal paths, wherein different ones of the sensors are not able to receive signals propagated from the plurality of signal sources along corresponding signal paths, when a user interacts with the touch sensitive screen from a first side or a second side of the vehicle.

23. The CRM of claim 22, wherein to process the sensor data to determine which of the sensors are able to receive signals from a corresponding plurality of signal sources comprises to process a first subset of the sensor data to determine which of a first subset of the sensors, if any, are not able to receive first signals from a first subset of signal sources propagated along a corresponding first subset of signal paths, and to process a second subset of the sensor data to determine which of a second subset of the sensors, if any, are not able to receive second signals from a second subset of signal sources propagated along a corresponding second subset of signal paths; wherein the first and second signal paths are orthogonal to each other, and disposed on a plane parallel to a surface plane of the touch sensitive screen.

24. The CRM of claim 21, wherein at least a second of the one or more infotainment subsystems differentially a first version of an user interface in response to a result of the determination that indicates the user is interacting with the touch sensitive screen from the first side of the vehicle and a second version of the user interface in response to the result of the determination that indicates the user is interacting with the touch sensitive screen from the second side of the vehicle.

25. The CRM of claim 21, wherein the first side is a driver side of the vehicle, and second side is a passenger side of the vehicle.
